(19) United States
(12) Patent Application Publication
(10) Pub. No.: US 2019/0129038 A1
(43) Pub. Date: May 2, 2019

(54) Monitoring System for a Mobile Device and Method for Monitoring Surroundings of a Mobile Device

(71) Applicant: OSRAM Opto Semiconductors GmbH, Regensburg (DE)

(72) Inventors: Christoph Goeltner, Cupertino, CA (US); Karl Leahy, Peidmont, CA (US)

(21) Appl. No.: 15/796,557

(22) Filed: Oct. 27, 2017

(51) Int. Cl. G01S 17/93; G08B 21/02

(52) U.S. Cl. CPC G01S 17/93; G01S 17/08; H04M 2250/12; G08B 21/02

(57) ABSTRACT

A monitoring system for a mobile device and a method for monitoring surroundings of a mobile device are disclosed. In an embodiment the monitoring system includes a sensor for scanning surroundings of the monitoring system, a control device configured to provide data about an object in the surroundings based on sensor data provided by the sensor and to determine a class of risk of the object based on the provided data, and an alert device coupled with the control device and configured to output an alert signal dependent on the determined class of risk.

### TECHNICAL FIELD

A monitoring system for a mobile device is provided. A mobile device with a monitoring system is provided. A method for monitoring surroundings of a mobile device is also provided.

### BACKGROUND

It is desirable to provide a monitoring system for a mobile device which can efficiently and reliably monitor the surroundings of a mobile device. It is also desirable to provide a mobile device which comprises such a system. It is also desirable to provide a method for monitoring the surroundings of a mobile device which allows an efficient and reliable monitoring of the surroundings of the mobile device.

### SUMMARY

According to at least one embodiment a monitoring system for a mobile device comprises a sensor for scanning the surroundings of the monitoring system. The sensor is configured to scan the surroundings of the monitoring system. According to embodiments the sensor is configured to emit electromagnetic radiation. According to further embodiments the sensor is configured to receive electromagnetic radiation, for example, electromagnetic radiation that is reflected from an object in the surroundings of the monitoring system. According to further embodiments the sensor is configured to emit and receive different kinds of signals, for example, soundwaves.

According to at least one embodiment the monitoring system comprises a control device. The control device is configured to provide data about the object in the surroundings based on sensor data provided by the sensor and to determine a class of risk of the object based on the provided data. For example, the control device is implemented as software. According to further embodiments the control device is implemented as hardware, for example, as a microcontroller. The control device is configured to process and handle the sensor data and information provided by the sensor. The control device is configured to process the sensor data and to identify information about the object in the sensor data.

Furthermore the control device is configured to determine whether the object is a risk. In particular, the control device is configured to determine whether the object is a risk for a user of the monitoring system. An object may be a risk if a collision may harm the user, for example. An object may be a risk if it could lead to an accident of the user, for example. The class of risk may be high in the case of a high probability that the user and the object may interfere with each other. In addition or as an alternative, the class of risk may be high if the effects of an interference between the user and the object is severe.

According to at least one embodiment the monitoring system comprises an alert device. The alert device is coupled with the control device. The alert device is configured to output an alert signal dependent on the determined class of risk. For example, the alert device is configured to output the alert signal when the class of risk is higher than a predetermined class of risk. When there is a certain probability that the user and the object may interfere with each other, for example, a collision between the user and the object, and the consequence of such an interference is bad, the alert signal is output. For example, different alert signals are output dependent on the determined class of risk.

A user of a mobile device can be focused on the mobile device, staring at the screen and not keenly aware of his surroundings. Furthermore psychological lack of attention may occur. For example, perceptual blindness may make it impossible for the user to attend to all stimuli in a given situation. The user fails to recognize an unexpected stimulus that is in plain sight. As a consequence, the user may fail to see the object in the surroundings. A user may be focused upon his mobile device without attention to his surroundings. This can be a significant safety hazard as distracted pedestrians cause accidents. Furthermore the user may walk without paying attention to his surroundings because the user is focused upon his mobile device, staring at the screen, and may run into an object which could be an obstacle like a staircase, a streetlamp, a fence or a rail or any other moving or stationary obstacle in the surroundings of the user and/or the mobile device.

With the monitoring system the improvement of safety for the user of the mobile device is improved. The object or obstacle is detected in the critical range in the surrounding. The control device and the alert device, which may be a hardware and/or a software application, coordinate the signals from the hardware components like the sensor and issues the alert signal. Accordingly, the mobile device user's safety is improved. The short range monitoring system detects within the surroundings of the mobile device and outputs the alert signal. Subsequently the mobile device user may be alerted to potential danger.

According to at least one embodiment the sensor is an optical sensor. For example, the sensor is configured to emit electromagnetic radiation like microwaves in the infrared spectrum or ultraviolet spectrum. Preferably the sensor uses electromagnetic waves which are not visible to the human eye. The sensor is configured to receive a corresponding electromagnetic waves. For example, the sensor comprises a photomultiplier or another photodetector. The sensor comprises a photodetector that converts light photons into current.

According to at least one embodiment the sensor is part of a Lidar system. For example, the control device and/or the sensor is configured to provide data about the object based on a time of flight method. The sensor and/or is designed to measure a time of flight of the reflected radiation, in particular of the reflected laser radiation. By the time of flight measurement, an actual distance between the monitoring system and the object can be determined.

In at least one embodiment, the sensor comprises a light source to emit laser radiation. The sensor comprises the detector to detect a proportion of the laser radiation reflected back at least one object illuminated by the laser radiation.

According to at least one embodiment the monitoring system comprises a further sensor system for providing motion data of the mobile device. The further sensor system comprises at least one of a position sensor, a gyroscope, an accelerometer and a compass. The control device is configured to determine the class of risk dependent on the provided motion data. The motion data comprises, for example, information about a geographical position of the monitoring system. Furthermore the motion data may comprise information about whether the monitoring system is moving or not. For example, when the monitoring system and the mobile device are not moving, a staircase in the surroundings of the mobile device gets a lower class of risk compared to a situation in which the mobile device is moving towards the staircase. Furthermore, objects can have another class of risk when the mobile device is in the vicinity of a road and when the mobile device is in a pedestrian zone. Furthermore, the speed and/or the direction of a movement can be included when determining the class of risk.

According to at least one embodiment the monitoring system comprises an information device. The information device is configured to provide information about a condition of the surrounding. The control device is configured to determine the class of risk depending on the provided information. The information about a condition of the surroundings may include weather information, traffic information or any other information that may affect the risk of the user. For example, a road may represent a higher risk at times when there is lots of traffic. At times when there is no traffic, the risk of the road may be lower. The weather may also influence the risk. Fog or rain may change the class of risk. For example, the information about the condition of the surroundings is received via a cellular network, wireless LAN or other systems.

According to at least one embodiment, the monitoring system is configured to scan a predetermined area of the surroundings around the monitoring system. The size of the predetermined area being variable and predetermined area is dependent on an operating state of the mobile device. For example, the predetermined area is larger when the mobile device is moving. When the mobile device is stationary and does not move, the area may be smaller. Furthermore, the operating state may include information the kind of use of the mobile device. When the user uses the mobile device in a way that necessitates a high level of attention, for example, a video call, the area may be larger. In an operating state which needs a lower level of attention, for example, choosing music, the area may be smaller.

According to at least one embodiment the data about the object comprises a parameter of the object. The parameter of the object may include the type of object, the speed of the object, possible danger from the object or any other parameter of the object that may influence risk if the object and the user interact with each other. For example, the parameter includes information whether the object is a car, a bike, a staircase or different kinds of object that may be in the surroundings of the mobile device. Furthermore, the parameter may include information about a direction of a movement of the object.

According to at least one embodiment, the control device is configured to predict a probability of a collision of the monitoring system and the object. For example, the movement of the monitoring system and the object are compared with each other. When the object and the monitoring system move in different directions, the probability of a collision is low. When the object is moving very fast and therefore may pass the user before the user and the object cross each other, the probability of a collision may also be low. When the trajectory of the object and of the mobile device are determined to cross each other, the probability of a collision is higher.

According to at least one embodiment, the control device is configured to receive information from an object danger library and to determine the class of risk depending on the received information. For example, the control device may exchange information and/or data with a cloud-based service. The object danger library may be part of the cloud-based service. The object danger library provides information about a potential risk of an object detected in the surroundings of the mobile device.

According to at least one embodiment a mobile device is provided which comprises a monitoring system according to at least one embodiment for scanning the surroundings of the mobile device. Thus, the mobile device is equipped with the monitoring system that is configured for scanning the surroundings of the mobile device and to output the alert signal if there is a potential risk for the user of the mobile device.

According to at least one embodiment, the monitoring system is configured to scan in horizontal and vertical directions in relation to the mobile device. When scanning in the horizontal direction as well as in the vertical direction an object in front of the mobile device as well as on a side of the mobile device can be detected. For example, the sensor comprises more than one radiation emitter and more than one radiation detector. The radiation emitters and detectors are arranged on different sides of the mobile phone to scan in the horizontal and the vertical directions.

According to embodiments the mobile device is configured to output at least one of an optical acoustic or haptic alarm signal depending on the alert signal. The alarm signal may be a change in the color of the screen of the mobile device. The alarm signal may be a flashlight or an audible audio signal. The alarm signal may be a vibrator alarm. Any combination of the different alarm signals is possible.

According to at least one embodiment, the mobile device is one of a smartphone and a tablet computer. Any other mobile device like a handheld game console or a music player may be equipped with the monitoring system.

According to at least one embodiment a method for monitoring the surroundings of a mobile device comprises the steps of: scanning the surroundings using a sensor of the mobile device; determining an object in the surrounding; determining a class of risk of the object; outputting an alert signal dependent on the determined class of risk.

Features for the method are also disclosed for the sensor system and vice versa.

According to at least one embodiment the method comprises: determining information with a sensor system of the mobile device, determining the class of risk dependent on the further information. For example, geographic information like position, speed of movement, direction of the movement or other information that influences the possibility of a collision between the mobile device and the object, is included when assessing the class of risk.

According to at least one embodiment the method further comprises receiving information about a condition of the surrounding, determining the class of risk dependent on the information about the condition of the surrounding. The condition of the surroundings may include information about the weather and/or traffic conditions and/or other conditions that may influence the determining of the object. For example, the information about the conditions is received via the internet.

According to at least one embodiment the method further comprises scanning the surroundings only after determination of a predetermined operating state of the mobile device. The scanning of the surroundings is only conducted when necessary. Thus, the method is efficient and a power-saving mode is possible. When the mobile device is in a standby mode the scanning of the surroundings is avoided. When it is detected that the mobile device is in an operating state where the user is focused upon the mobile device, the scanning of the surroundings is started.

According to at least one embodiment the method further comprises adapting the resolution of the scanning dependent on an operating state of the mobile device. For example, when the mobile device is moved fast, the resolution is higher than when the mobile device is not moved. For example, when it is detected that the mobile device is in a train, the resolution is lower than when the mobile device is used near a road with high traffic. For example, the resolution is adapted depending the kind of use of the mobile device. When playing a game with the mobile device the resolution is higher than during a phone call when the mobile device is at the ear of the user.

According to at least one embodiment, the method further comprises outputting at least one of an optical, acoustic and haptic alarm signal dependent on the alert signal.

### BRIEF DESCRIPTION OF THE DRAWINGS

A monitoring system, a mobile device and a method described herein are explained in greater detail below by way of exemplary embodiments with reference to the drawings. Elements which are the same in the figures are indicated with the same reference numbers. Relationships between the elements are not shown to scale.

FIG. 1 shows a schematic representation of a mobile device with a monitoring system according to an embodiment;

FIG. 2 shows a schematic representation of a user with a smartphone with a monitoring system according to an embodiment;

FIGS. 3 and 4 show schematic representations of a mobile device with a monitoring system according to an embodiment;

FIG. 5 shows a schematic representation of an object detection according to an embodiment;

FIG. 6 shows a schematic representation of a mobile device with a monitoring system according to an embodiment;

FIG. 7 shows a schematic representation of a sensor according to an embodiment;

FIG. 8 shows a schematic representation of a sensor according to an embodiment;

FIG. 9 shows a schematic representation of a monitoring system according to an embodiment; and

FIG. 10 shows a flowchart of an operation method for a monitoring system according to an embodiment.

### DETAILED DESCRIPTION OF ILLUSTRATIVE EMBODIMENTS

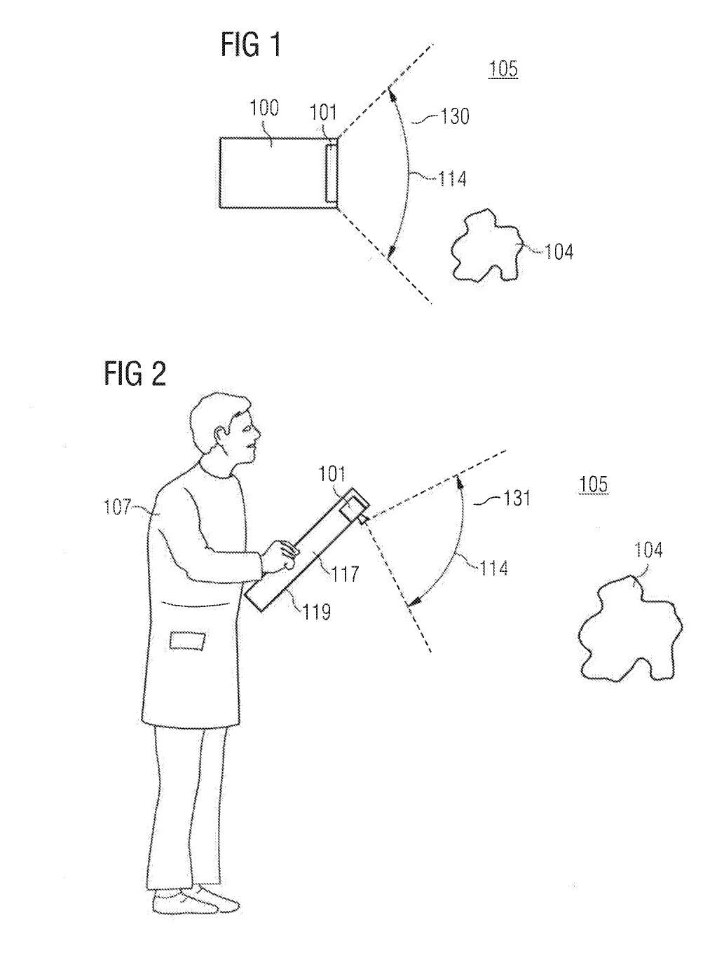

FIGS. 1 and 2 each shows an exemplary embodiment of a mobile device 100. The mobile device 100 may be a smartphone. The mobile device 100 may be any other kind of portable personal computer with features for handheld viewing. The mobile device 100 comprises a monitoring system 101 for scanning surroundings 105 of the mobile device 100. The monitoring system 101 is used for determining an object 104 in the surroundings 105 of the mobile device 100. In particular, a predetermined area 114 of the surroundings 105 is scanned by the monitoring system 101 to detect the object 104 and warn a user 107 of the mobile device 100 if there is a potential risk caused by the object 104. For example, the monitoring system 101 is used to warn the user 107 about a potential collision with the object 104.

The smartphone user 107 may be walking and staring at the screen of the mobile device 100. An obstacle like the object 104 gets in his sphere. Due to the intensive focus on the mobile device 100, the user 107 may oversee the object 104. The monitoring system 101 detects the object 104 within a critical range 114 and alerts the user 107 to potential danger.

The object 104 may be a moving object like a vehicle or another pedestrian and/or may be a fixed immovable object like a curb, a fountain, a staircase, a streetlight, a parked car or any other object the user 107 may stumble over or crash into.

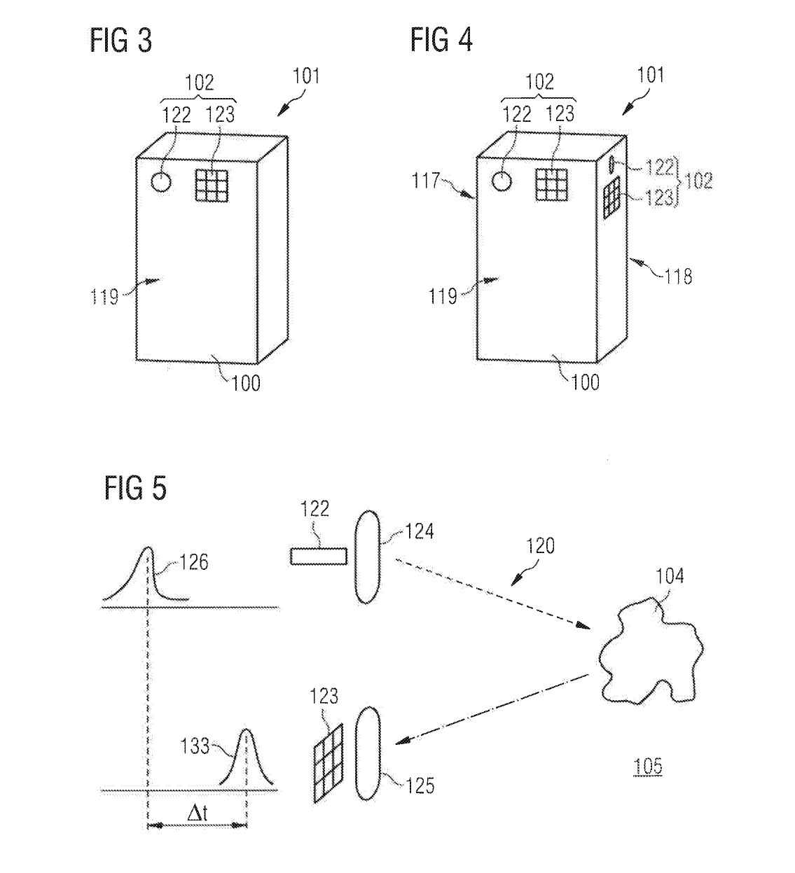

As shown with respect to FIGS. 3 and 4 the monitoring system 101 comprises at least one sensor 102. The sensor is configured to scan the surroundings 105. For example, the sensor 102 comprises an optical-based emitter like a laser light source 122. The sensor 102 further comprises a light detector 123 which is configured to detect light from the light source 122, which is reflected by the object 104. The sensor 102 is a short range optical-based emitter and sensor system, for example.

According to embodiments, the sensor 102 is part of a Lidar system. The monitoring system 101 with the sensor 102 is a low resolution active optical system configured to detect the object 104 in the surroundings 105, in particular in the predetermined area 114. The sensor 102 comprises the light source 122 which is an infrared laser or an infrared LED, for example. The sensor 102 further comprises the detection 123 which may be a photodiode array or a low resolution camera.

The monitoring system 101 further comprises a control device 103 (FIG. 9). The control device 103 is configured to control the sensor 102. The control device 103 is configured to receive sensor signals from the light detector 123. For example, the control device 103 uses the time of flight of the light emitted by the light source 122 to perform the appropriate timing of the light emission and detection. Furthermore, the control device 103 is configured to perform an appropriate signal conditioning.

The sensor 102 is arranged at a back 119 of the mobile device 100. The back 119 is at an opposite side of the screen of the mobile device 100, for example. According to further embodiments additional sensors 102 are arranged at the sides 117 and 118 of the mobile device 100 as shown in FIG. 4. Additional sensors 102 on other positions of the mobile device 100 are possible. The sensors 102 are arranged at the mobile device 100 dependent on the area 114 of the surroundings 105 which should scanned. As shown in FIG. 1, a horizontal field of view 130 is realized by the monitoring system 101 with the sensors 102. As shown in FIG. 2 a vertical field of view 131 is realized by the monitoring system 101 with the sensors 102. Hence the object 104, which may be in front of or at the side of the mobile device 101, can be detected. For example, a car which comes closer from the side of the mobile device 100 can be detected with the monitoring system 101.

FIG. 5 shows the principle of the detection of the object 104 using the light source 122 and the light detector 123 and the time of flight technology. A light signal 126 is emitted from the light source 122. An optic 124, for example, a lens, may be arranged for focusing or influencing a light pulse 120 of the emitted light. The emitted light is reflected by the object 104 and detected with the light detector 123. The light detector 123 may comprise an optic 124, for example, a lens, for influencing the light. The light detector 123 receives the reflection 133. The time between the peak of the emitted light signal 123 and the received reflection 133 indicates the distance between the monitoring system 101 and the object 104. By monitoring a change in the distance, a relative movement between the monitoring system 101 and the object 104 can be determined.

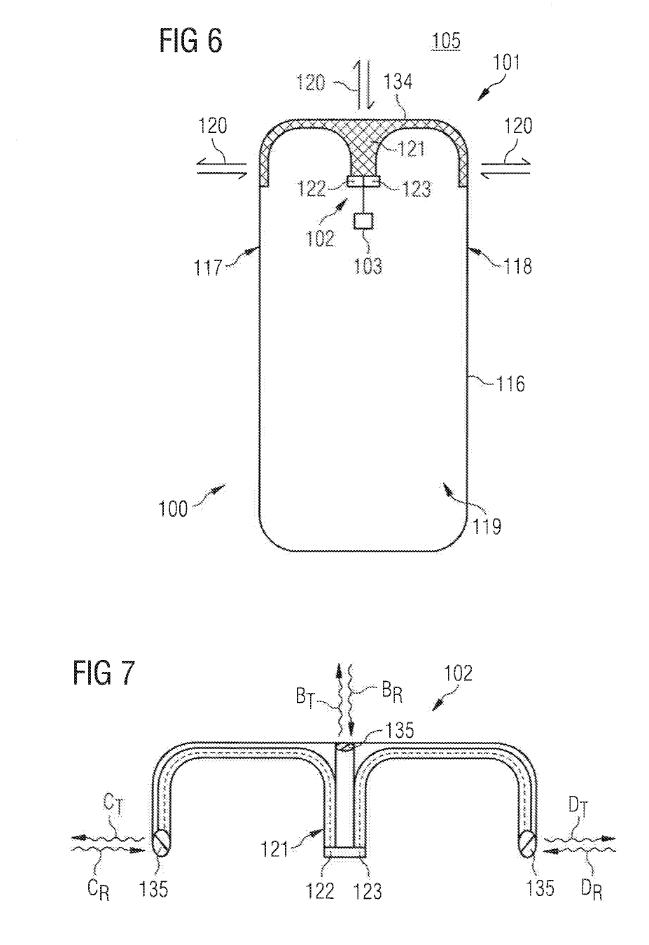

FIG. 6 shows the mobile device 100 with the monitoring system 101 according to a further embodiment. The sensor 102 comprises a single light source 122 and a single light detector 123. Light guides 121 are used to guide the emitted light signal 126 and the received reflection 133 from the light source 122 to the surroundings 105 and from the surroundings 105 to the light detector 123. A plurality of light pulses 120 may be realized to scan the predetermined area 114. For example, light is emitted at the sides 117 and 118 on the back 119 and/or a top 134 of the mobile device 100.

The monitoring system 101 with the sensor 102 and the light guides 121 as well as the control device 103 may be arranged inside a housing 116 of the mobile device 100.

FIG. 7 shows the light guide 121 in more detail according to an embodiment. The light guide 121 is a bidirectional extruded material light guide. Hence, the light from the light source 122 can be guided to different outputs 135 on the mobile device 100. The reflection 133 is received at the various outputs 135 as well.

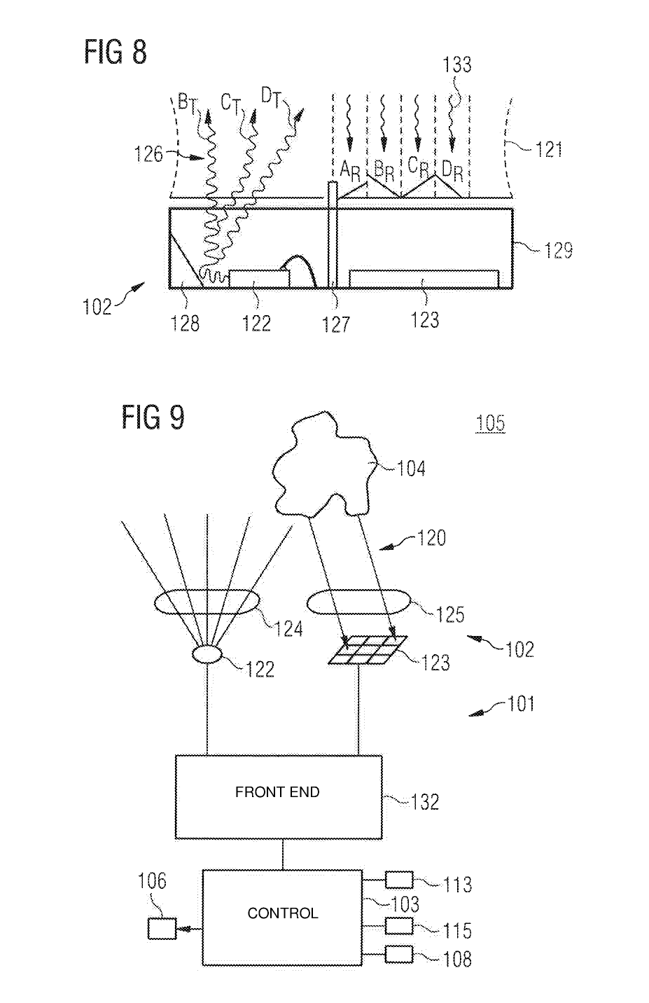

FIG. 8 shows an exemplary embodiment of the sensor 102 according to embodiments. The sensor 102 comprises the light source 122 and the light detector 123. An optical isolator 127 is arranged between the light source 122 and the light detector 123. The optical isolator 127 is a mechanical barrier for optical isolation. For example, the optical isolator 127 is used for mounting of the waveguides 121 as well.

The light source 122 is an edge-emitting laser diode, for example. The emitted light is reflected by a mirror 128 and coupled into the light guide 121. The received reflection 133 is guided by the light guide 121 to the light detector 123 which may be a quad array PIN diode. For example, the light detector 123 comprises a laser monitor diode (AR), an N plane diode (BR), a W plane diode (CR) and an E plane diode (DR), see FIG. 7.

FIG. 9 shows an exemplary embodiment of the monitoring system 101. The light source 122 and the light detector 123 are coupled with the control device 103 via a front end 132. The front end 132 may be an analog front end with drivers for the light source 122 and the light detector 123 as well as signal amplification and/or signal processing.

The control device 103 may be a microcontroller with an appropriate AD stage. For example, a software with the appropriate object detection algorithm is running on the microcontroller to enable the functionality.

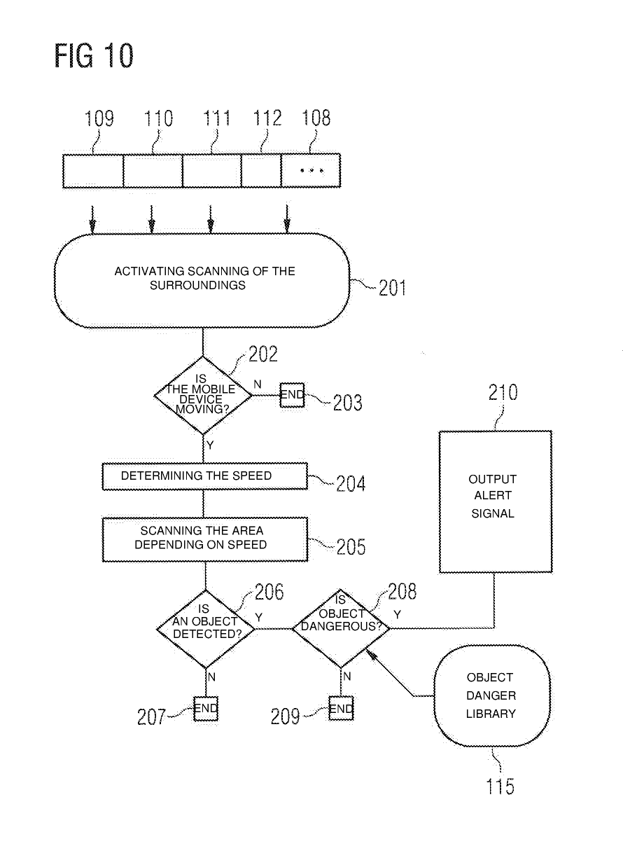

The control device 103 is coupled to a sensor system 108. The sensor system 108 comprises further sensors of the mobile device 100. As shown in FIG. 10, the sensor system 108 comprises at least one of a position sensor 109, like a GPS sensor, a gyroscope 110, an accelerometer 111 and a compass 112. The sensor system 108 comprises information about the geographical position of the mobile device 100, a speed of a movement of the mobile device 100, another position and motion-dependent information.

The control device 103 is coupled with an information device 113. The information device provides further information about the surroundings 105 of the mobile device 100. For example, the information device 113 collects information from databases over a mobile network. The further information may comprise information about the weather, how crowded the surroundings 105 is at that moment, the traffic situation or any other information that may influence the detection and assessment of the object 104.

The control device 103 is coupled with an object danger library 115. The object danger library 115 is a library which provides information about a potential risk for the user 107 of a detected object 104.

For example, when the monitoring system 101 detects a tree as the object 104 the object danger library 115 provides a corresponding risk value for a tree. When the object 104 is detected as a fast-moving vehicle, the object danger library 115 provides a risk value for the fast-moving car which may be different to the risk value of the tree, in particular higher.

The control device 103 is configured to determine a possible risk for the user 107 dependent on the signals of the sensor 102, the information from the sensor system 108, the information from the information device 113 and the information from the object danger library 115. Dependent on all the information, the control device 103 determines a class of risk of the object 104.

An alert device 106 is coupled with the control device 103. The alert device 106 is configured to output an alert signal dependent on the determined class of risk. For example, the alert signal cause the mobile device 100 to output an alarm signal like an audio signal, a vibration alarm or a change of the depiction on the screen on the monitoring system 101. Also, a text message or the like may be shown on the screen of the mobile device 100 dependent on the alert signal.

FIG. 10 shows an exemplary embodiment of a method for scanning the surroundings 105 of the mobile device 100. Dependent on the information provided by the sensor system 108, the scanning of the surroundings 105 is activated in step 201. According to embodiments, to save energy, the monitoring system 101 is only activated when needed.

Raw data from the sensor system 108, like the GPS signal, is used to decide whether the monitoring system 101 is necessary or not.

For example, assisted GPS is used. A mobile station-based locating may be used. Different information is used to acquire the satellites more quickly. Orbital data or the almanac for the GPS satellites is used to enable the position sensor 109 to lock to the satellites more rapidly. A mobile station-assisted locating is possible. The position of the mobile device 100 is calculated using information from the position sensor 109. The mobile device 100 captures a snapshot of the GPS signal with approximate time for the server to later process into a position. The system server has a good satellite signal and plentiful computation power so it can compare fragmentary signals relayed to it. Accurate surveyed coordinates for the cell site towers allow better knowledge of local ionospheric conditions and other conditions affecting the GPS signal than the position sensor 109 alone, enabling a more precise calculation of the position of the mobile device 100.

Overlaying this exacting position with software such as Google Maps or Open Street Map enables the mobile device to know the surroundings 105 of the mobile device 100. For example, the control device 103 can detect whether the mobile device 100 is in the immediate vicinity of a road or a track that is designate to have fast-moving vehicles present.

When the control device 103 detects that the mobile device is in use by the user 107 and that the user is moving towards an area of risk like a road, then the control device 103 turns the monitoring system 101 on in step 201. For example, the Lidar system with the light source 122 and the light detector 123 is turned on. Hence, the monitoring system 101 is only completely turned on, when the phone is detected as being in a surroundings 105 with possible risks for the user 107. For example, the monitoring system 101 is only turned on when the mobile device 100 is detected as moving, e.g., walking and/or moving by other means.

However, the monitoring system 101 can be activated even if the mobile device is not moving when the surroundings 105 is near a road or another area where lots of moving objects are present which may move towards the mobile device 100 and the user 107. When it is detected that the monitoring system 101 may be useful, all available sensor data of the phone is used. The sensor 102 is turned on.

In step 202 it is detected whether the mobile device 100 is moving or not. When the mobile device 100 is not moving the method may be ended in step 203.

When the mobile device 100 is moving, the speed of movement is determined in step 204.

In step 205 the area 140 which is scanned is determined dependent on the determined speed. Furthermore, it is possible to adapt the resolution of the scanning dependent on the determined speed of movement. The search resolution is optimized as a function of speed in order to preserve power consumption.

When the monitoring system 101 detects no object in step 206, in step 207 the method will start again. Otherwise, when the monitoring system 101 is no longer necessary, for example, because the mobile device 100 is outside of an area of risk, the sensor 102 may be turned off. This helps to avoid draining the battery of the mobile device 100.

If the object 104 is detected in step 206, a possible danger of the object 104 is assessed in step 208. For example, parameters like speed of the object are determined. In addition the sensed data is compared to data of the object danger library 115 to assess a potential risk of the object 104. It is determined whether there is a danger of collision and the effect of a potential collision. When it is detected that the object 104 is no risk for the user 107, the method ends in step 209 or starts in step 202 again. When the object 104 is assessed as a potential risk for the user 107, in step 210 the alert signal and the alarm signal are output.

The mobile device 100 with the monitoring system 101 allows an intelligent scanning of the surroundings 105 and a protection of the user 107 to avoid collisions or other accidents like stumbling. The assessment of the risk of the object 104 is improved according to embodiments by taking further data into consideration. For example, the data of the sensor system 108 and/or the information device 113 and/or the object danger library 115 are used to improve the prediction of the risk of the object 104. Thus the accuracy and exactness of the prediction is improved. The mobile device 101 is configured to scan on the sides 117 and 118 of the mobile device 100 to detect objects 104 that are moving from the side towards the mobile device 100, like a car that comes closer from the left. The monitoring system 101 is also configured to scan the surroundings 105 in front of the back 119 to detect obstacles in direction of a movement of the user 107, like a step or an garbage can.

The monitoring system 101 coordinates various sensor inputs to allow the sensor 102 to be turned off when the user is not moving. The monitoring system 101 coordinates the signals from the individual hardware components and issues a warning signal to the user, like a blinking red light or an acoustic signal in the case of the detection of a potential risk. Thus a significant improvement of a smartphone user's safety is possible. Instead of an optical sensor 102 and/or the time of flight method other 3D sensing technology can be used, like structured light, scanning or other methods that allow a monitoring of the surroundings 105. The monitor system 101 according to an embodiment using a low resolution Lidar system to sense the object 104 that may be overseen by the user of the mobile device 100, for example, due to perceptual blindness.

The Lidar system can take active measurements in real time so that the user is informed and warned and can make appropriate decisions. With the Lidar system it is possible to image objects. It can target a wide range of materials, including non-metallic objects, rocks, persons, animals and other types of objects. A narrow laser-beam can map physical features. The mobile device 100 with the monitoring system 101 is extended with an active warning capability. The small form factor of the monitoring system 101 enables the monitoring system 101 to be embedded into existing mobile phone factors like the housing 116. No major industrial redesign is needed. The self-activated monitoring system 101 using the sensor system 108 and/or the information device 113 leads to significant power savings, for example, when the sensor 102 is only pulsed when the mobile device 100 is close to a road or a carpark.

The invention described here is not restricted by the description given with reference to the exemplary embodiments. Rather, the invention encompasses any novel feature and any combination of features, including in particular any combination of features in the claims, even if this feature or this combination is not itself explicitly indicated in the claims or exemplary embodiments.

1. A monitoring system for a mobile device, the monitoring system comprising:
a sensor configured to scan surroundings of the monitoring system and to provide sensor data, wherein the sensor comprises a light source, a light detector and light guides configured to guide light from the light source and to the light detector, and wherein the light guides end at different outputs;
a control device configured to provide data about an object in the surroundings based on the sensor data and to determine a class of risk of the object based on the sensor data;
an alert device coupled with the control device and configured to output an alert signal dependent on the determined class of risk; and
an information device configured to provide information about a condition of the surroundings,
wherein the condition of the surroundings include at least one of weather information or traffic information, and
wherein the control device is configured to determine the class of risk dependent on the information.

2. The monitoring system according to claim 1, wherein the sensor is an optical sensor.

3. The monitoring system according to claim 1, wherein the sensor is part of a Lidar system.

4. The monitoring system according to claim 1, wherein the control device is configured to provide the data about the object based on a time of flight method.

5. The monitoring system according to claim 1, further comprising a further sensor configured to provide motion data of the mobile device, the further sensor comprising at least one of a position sensor, a gyroscope, an accelerometer and a compass, wherein the control device is configured to determine the class of risk dependent on the motion data.

6. (canceled)

7. The monitoring system according to claim 1, wherein the sensor is configured to scan a predetermined area of the surroundings around the monitoring system, and wherein a size of the area is variable and predetermined depended on an operating state of the mobile device.

8. The monitoring system according to claim 1, wherein the data about the object comprises a parameter of the object.

9. The monitoring system according to claim 1, wherein the control device is configured to predict a probability of a collision of the monitoring system and the object.

10. The monitoring system according to claim 1, wherein the control device is configured to receive information from an object danger library and to determine the class of risk dependent on the received information.

11. The mobile device comprising:
the monitoring system according to claim 1, wherein the monitoring system is configured to scan surroundings of the mobile device.

12. The mobile device according to claim 11, wherein the monitoring system is configured to scan in horizontal and vertical directions in relation to the mobile device.

13. The mobile device according to claim 11, wherein the mobile device is configured to output at least one of an optical, acoustic or haptic alarm signal dependent on the alert signal.

14. The mobile device according to claim 11, wherein the mobile device is one of a smart phone or a tablet computer.

15. A method for monitoring surroundings of a mobile device, the method comprising:
scanning the surroundings using a sensor of the mobile device, wherein the sensor comprises a light source, a light detector and light guides configured to guide light from the light source and to the light detector, and wherein the light guides end at different outputs;
providing information about a condition of the surroundings, wherein the condition of the surroundings include at least one of weather information or traffic information;
determining an object in the surroundings;
determining a class of risk of the object, wherein determining the class of risk depends on the information; and
outputting an alert signal dependent on the determined class of risk.

16. The method according to claim 15, further comprising determining the class of risk dependent on further information.

17. (canceled)

18. The method according to claim 15, further comprising scanning the surroundings only after determining of a predetermined operating state of the mobile device.

19. The method according to claim 15, further comprising adapting a resolution of the scanning dependent on an operating state of the mobile device.

20. The method according to claim 15, further comprising outputting at least one of an optical, acoustic or haptic alarm signal dependent on the alert signal.

21. The monitoring system according to claim 1, wherein the sensor includes an optical isolator separating the light source and the light detector.

22. The mobile device according to claim 11, wherein the outputs are located at sides of the mobile device and at a back of the mobile device.
